(19) United States
(12) Patent Application Publication
(10) Pub. No.: US 2005/0203840 A1
(43) Pub. Date: Sep. 15, 2005

(54) Method for calculating and displaying trading information

(76) Inventor: Aurelio Robles, Guadalajara (MX)

Correspondence Address: Jonathan Feuchtwang, Suite 1200, 150 N. Wacker Drive, Chicago, IL, 60606, US

(21) Appl. No.: 10/993,539

(22) Filed: Nov. 19, 2004

Related U.S. Application Data
(60) Provisional application No. 60/552,655, filed on Mar. 12, 2004.

(51) Int. Cl. G06F 17/60

(52) U.S. Cl. 705/39

(57) ABSTRACT

A financial analysis system, comprising means for analyzing transaction information for a given item on a transaction by transaction basis to distinguish between aggressive buying and aggressive sales behavior; and means for displaying the analyzed transaction information.

### RELATED APPLICATION

This application claims priority from U.S. Provisional Application Ser. No. 60/552,655 filed Mar. 12, 2004.

### TECHNICAL FIELD OF THE INVENTION

The present invention relates generally to a method for analyzing and displaying financial information or the like. More particularly, the present invention relates to a method for decoding transactional information received from an exchange to assess the “aggressiveness” of buyers 5 and sellers. Stated slightly differently, the present invention enables the user to visualize differences of attitude and behavior which in the nomenclature of the present invention is termed aggressive selling and aggressive buying.

### BACKGROUND OF THE INVENTION

Conventionally, financial or commodity exchanges collect data regarding the price and quantity of each executed transaction. This transaction data is then sold to distributors who in turn resell the data to the final consumer.

This data contains a wealth of information, and is analyzed to determine trends in buying and selling. The timeliness of the analysis is crucial; the data must be analyzed and absorbed in more or less real time if the data is to have any value.

The most common presentation of the transaction data is in the form of a bar chart which shows the price range of a specified interval.

The conventional bar chart presentation of transaction data fails to provide information critical for judging the ebb and flow of the market.

Accordingly, what is needed is a method for presenting transaction data which enables the viewer to dissect the supply and demand that took place at any given price level.

### BRIEF DESCRIPTION OF THE DRAWINGS

FIG. 1 depicts an improved financial chart according to the present invention;

FIGS. 2A and 2B are flow diagrams of the algorithm of the present invention; and

FIGS. 3-6 are examples of the improved financial chart of the present invention.

### DETAILED DESCRIPTION OF THE INVENTION

A conventional bar chart is only capable of displaying a range of the prices at which transactions were executed during each time interval are depicted as a range. A conventional bar chart merely depicts a starting or initial price, a final price and a range of sales prices at which items or goods were transacted during the interval. While conventional bar charts are useful, they do not provide the viewer with insight regarding the attitude of the buyer or sellers. Notably, they fail to provide information regarding the volume transacted at each price within the interval.

The present invention uses a novel term “aggressive buyer” to refer to a buyer anxious to execute his or her transaction without limiting his order at a specified price. The aggressive buyer will buy at what ever price is asked for in the market. Correspondingly, the novel term “aggressive seller” refers to a seller anxious to execute his or her transaction without waiting for a buyer to come to his/her price. The aggressive seller will sell at the best bid price in the market without limiting his order to a specified price. It should be understood that the term “aggressive buyer” is equivalent in every aspect to a “passive seller”, and that the term “aggressive seller” is equivalent in every aspect to a “passive buyer”. The equivalence between aggressive buyer and passer seller is due to the fact that each transaction must involve a buyer and a seller. If the buyer is aggressive then the seller must be passive otherwise they would never agree on a price.

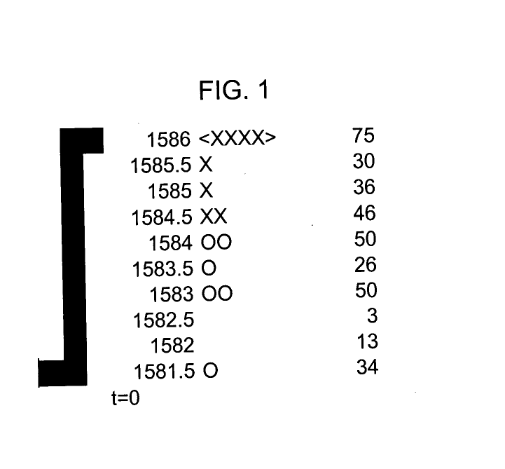

FIG. 1 is an improved graph according to the present invention which not only displays the weight accorded every price during the period but further dissects the transaction information to distinguish the aggressive buyers (passive seller) from the aggressive sellers (passive buyer). A graph according to the method of the present invention provides significant advantages over conventional graphs.

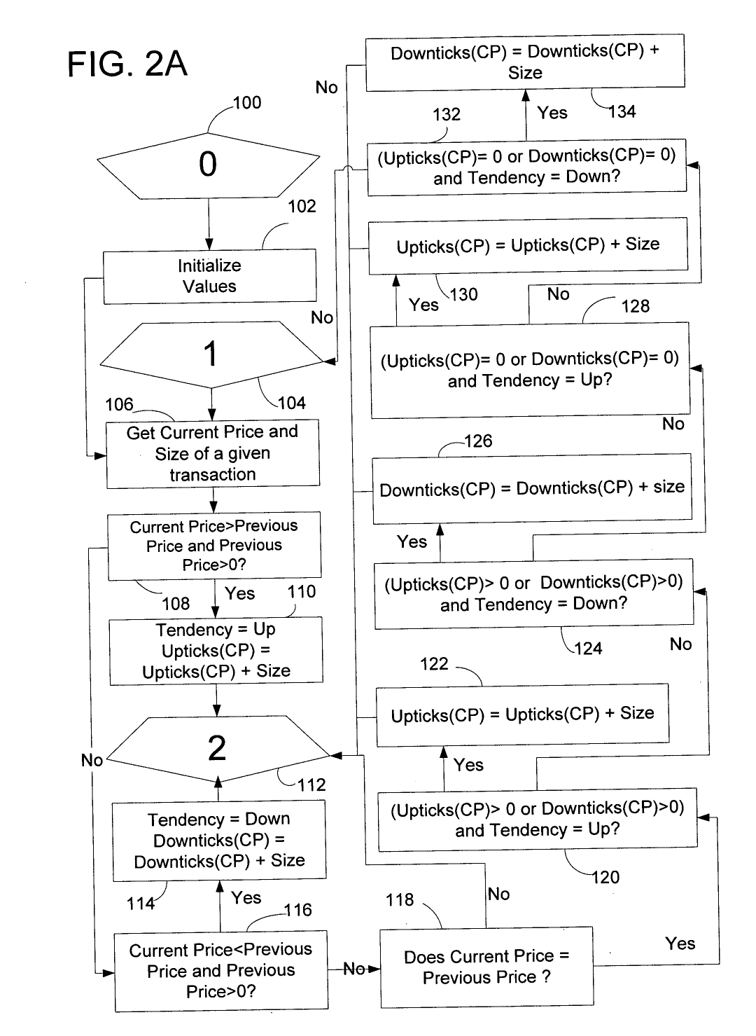

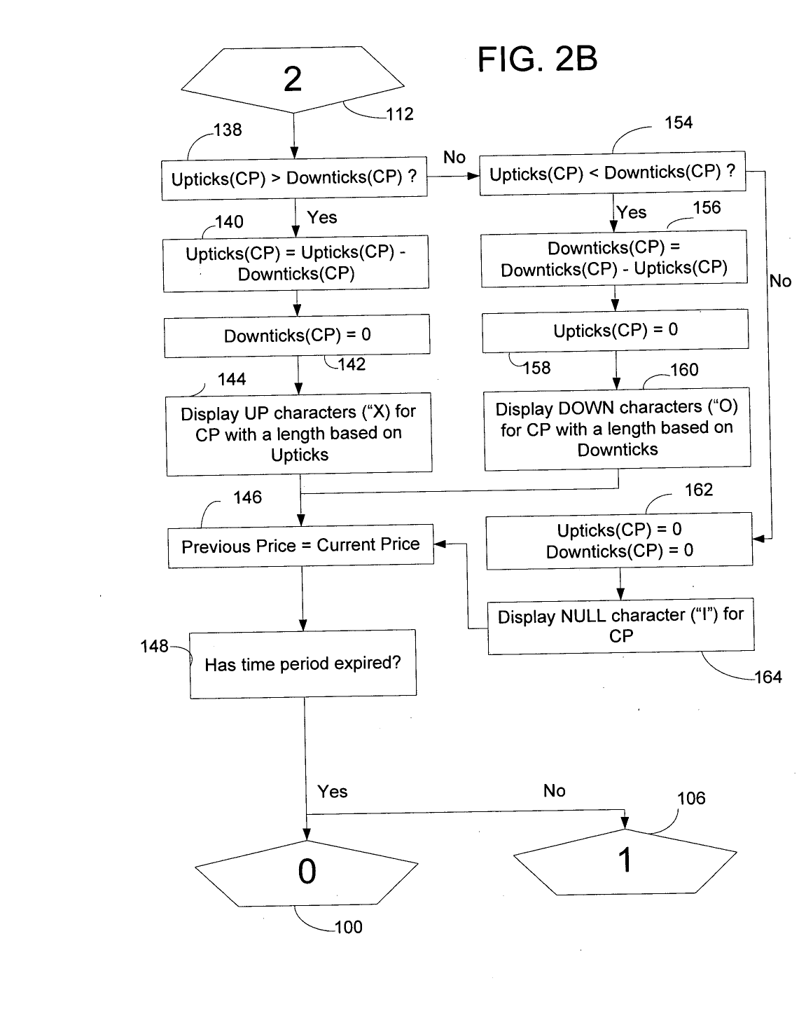

Using conventional methods there was no way to know whether there was more aggressive buying than aggressive selling in any time period. But using the Market Activity Flow method of the present invention (FIGS. 2A and 2B) we are able to assess from one time interval to the other if there is more aggressive buying or less aggressive buying.

At first glance the task of dissecting the buying and selling at any particular price seems impossible because by definition for every buyer there is a seller. This means that the amount purchased must equal to the amount sold.

If an investor or trader wants to purchase a security, derivative, commodity, contract or the like he has one of two choices. He can either limit his buy order at the specified price which will be call the bid price or he can place a type of market order to buy at the ask price.

If the exchange knew which choice the participant had taken they would be in the position to know how much aggressive buying or selling occurred at a particular price at any given point in time. Regardless of whether the exchange has the ability to know if the participant enters the market with a type of limit order or a type of market order to dissect this kind of behavior, they do not give or sell this information.

Importantly, without information regarding limit orders it has not been possible, using conventional financial analysis, to know how much aggressive buying and or selling was done at a particular price in time.

The Market Activity Flow method of the present invention provides a novel method for identifying aggressive buying or selling behavior from currently available transaction information.

As shown in FIG. 1, the “X's” represent aggressive buying and “O's” represent aggressive selling within a given time interval. The improved financial chart enables the viewer to immediately determine that there was a lot of aggressive buying at a given price.

The method of the present invention calculates and displays aggressive buying and aggressive selling within a predefined user-selected time interval.

According to the method of the present invention transactions are evaluated on an individual basis, generally in real-time.

The Market Activity Flow method determines that aggressive buying occurs when the current price for the goods is greater than the previous price for goods (FIG. 2A, step 108). Likewise, aggressive selling occurs when the current price for the goods is less than the previous price for goods (FIG. 2A, step 116).

If the current price is equal to the previous price (FIG. 2A, step 118) then the Market Activity Flow method looks to the previous transaction to see whether it was characterized as aggressive buying (FIG. 2A, step 120) or aggressive selling (FIG. 2A, step 124) and assumes that the current transaction has the same characterization. Thus if the current price is equal to the previous price and the previous transaction was aggressive buying then the current transaction is attributed to aggressive buying.

The Market Activity Flow maintains counters for transactions at each price, summing the number of goods aggressively purchased at a given price less the number of goods aggressively sold at that same price. These counters are designated Upticks (CP) and Downticks (CP) in the flow diagram of FIGS. 2A-2B, where CP is shorthand for current price. The Upticks and Downticks are evaluated at a given price hence the notation Upticks (CP) or Downticks (CP) refers to the counter for price CP.

Once the current transaction has been examined and the Uptick or Downtick value calculated, the Market Activity Flow method evaluates whether to display aggressive buying (denoted by “X's”), aggressive selling (denoted by “O's”) or indeterminate or null (denoted by “I”).

It was previously stated that aggressive buying is judged when the current price is greater than the previous price. However, if the volume of aggressive buying calculated in steps 110, 120 or 128 is less than the previously calculated volume of aggressive sales at the given price (step 154) then the volume of aggressive sales will be reduced by the volume of aggressive buying (FIG. 2B, step 156) and the volume of aggressive sales (O's) will be displayed (FIG. 2B, step 160).

Likewise, it was previously stated that aggressive selling is judged when the current price is lower than the previous price. However, if the volume of aggressive selling calculated in steps 116, 124 or 132 is less than the previously calculated volume of aggressive sales at the given price (FIG. 2B, step 138) then the volume of aggressive sales will be reduced by the volume of aggressive sales (FIG. 2B, step 140) and the volume of aggressive buying (X's) will be displayed (FIG. 2B, step 144).

A special circumstance (denoted a null or indeterminate position) occurs when the calculated Uptick value equals the calculated Downtick value (FIG. 2B, step 162). In a null position the Market Activity Flow method displays a character or symbol such as an “I” to denote that the aggressive sales balances out aggressive buying at the given price (FIG. 2B, step 164).

The Market Activity Flow maintains counters for transactions at each price, summing the number of goods aggressively purchased at a given price less the number of goods aggressively sold at that same price. These counters are designated Upticks (CP) and Downticks (CP) in the flow diagram of FIGS. 2A-2B, where CP is shorthand for current price. The Upticks and Downticks are evaluated at a given price. Consequently, the graph of aggressive buying/selling shown in FIG. 2 enables the user to visualize the price at which aggressive buying is occurring and the volume of aggressive buying as well as the price at which aggressive selling is occurring and the volume of aggressive selling within the time period.

One of ordinary skill in the art will appreciate that a single counter, e.g., UpDowntick (CP) may be used in place of the separate Uptick (CP) and Downtick (CP) counters.

The Market Activity Flow method of the present invention will be better understood by working through several numerical examples.

Table 1 contains sample transaction data for a series of financial transactions. Each entry in Table 1 represents a transaction which was executed within a given time interval.

TABLE 1

| Transaction | Price | Volume |
|---|---|---|
| 1 | 7675 | 3 |
| 2 | 7680 | 13 |
| 3 | 7675 | 6 |
| 4 | 7680 | 1 |
| 5 | 7680 | 5 |

The method of the present invention uses the current price (“CP”) and previous price of the goods (stock, commodity or the like) being traded, and the volume of goods being transacted. This information is used to calculate for each price at which goods were transacted within the interval, the Upticks or Downticks as well as the upward or downward tendency of transactions. If the current price (CP) is greater than the previous price the Market Activity Flow procedure of the present invention judges the transaction to that of an aggressive buyer. Alternatively, if the current price is lower than the previous price the Market Activity Flow procedure of the present invention judges the transaction to that of an aggressive seller.

Upticks/Downticks are counters which track the number of aggressive purchases and aggressive sale transactions at a given price. Purchases (aggressive buying) at a given price are offset by sales (aggressive sales) at that price. According to the methodology of the present invention Upticks (CP) (aggressive buyer) and Downticks (CP) (aggressive sales) represent the volume or size of a transaction at price CP.

Turning to FIG. 1, the variable “Upticks” is graphically represented as the number of X's at a given price, the variable “Downticks” is graphically represented as the number of O's at a given price.

At the beginning of each time interval the tendency is reset to <null>, the previous price is set to 0, and all of the Uptick and Downtick counters are reset to 0 (steps 100, 102). The current price and size are obtained from the exchange which is represented herein by Table 1 (step 106). If the current price>previous price and previous price>0 (step 108) then processing flows to step 110. However, in the present example the last price was set to 0 in step 102 and thus processing flows to step 116. In step 116 the previous price is 0 so processing flows to step 118.

The current price (which is 7675) is not equal to the previous price (step 118) so processing flows to step 112 (FIG. 2B). The Uptick counter for 7675 is not greater than the Downtick counter for 7675 because both were set to 0 in step 102 so step 138 is judged false and processing flows to step 154. Likewise the Uptick counter for 7675 is not less than the Downtick counter for 7675 because both were set to 0 in step 102 so processing flows from step 154 to step 162. The Uptick counter for 7675 (current price) and Downtick counter for 7675 are initialized to 0 (step 162) and the symbol “I” is displayed (step 164) because since this is the first value in the interval we can not judge whether there has been aggressive buying or aggressive selling, and the previous price is set to equal the current price (step 146) which in our example is 7675. If the time period for the interval has expired (step 148) then the values are again initialized (step 102); otherwise, transaction information is again obtained from the exchange (step 106).

Table 2 summarizes the values of each of the variables.

TABLE 2

| | Previous | Current | | | | | |
|---|---|---|---|---|---|---|---|
| Trans | Price | Price | Size | Upticks(CP) | Downticks(CP) | Tendency | Display |
| 1 | 0 | 7675 | 3 | Upticks(7675) = 0 | Downticks(7675) = 0 | Null | I |
| 2 | 7675 | 7680 | 13 | | | | |

For the purposes of this example, the time period has not yet expired and the new values are fetched for current price and size in step 108. See second transaction in Table 2. At first transaction at the price of 7675 with traded volume of 3 is not represented as either an aggressive buyer or an aggressive seller since there is no way of knowing what direction was the last tick.

The second transaction at the price of 7680 is greater than the previous level of 7675 (step 108) and therefore the Market Activity Flow™ interprets that it was at the asking price (upside or aggressive buying) and sets the tendency Up and increments the Upticks(7680) to 13 (step 110). At this point the Upticks(7680)>Downticks(7680), we offset Upticks(CP) by any pre-existing number of Downticks(CP) (steps 140, 142) and display enough X's to represent the amount of volume paid from the aggressive buyers to the passive sellers (step 144). Once again, the previous price is set to equal the current price (step 146). If the time period for the interval has expired (step 148) then the values are again initialized (step 102); otherwise, transaction information is again obtained from the exchange (step 106). Table 3 summarizes the values of each of the variables.

TABLE 3

| | Previous | Current | | | | | |
|---|---|---|---|---|---|---|---|
| Trans | Price | Price | Size | Uptick(CP) | Downtick(CP) | Tendency | Display |
| 1 | 0 | 7675 | 3 | Uptick(7675) = 0 | Downtick(7675) = 0 | Null | I |
| 2 | 7675 | 7680 | 13 | Uptick(7680) = 13 | Downtick(7680) = 0 | UP | X's |
| 3 | 7680 | 7675 | 6 | Uptick(7675) = 0 | Downtick(7675) = 6 | Down | O's |

On this third transaction, the current price (7675) is below the previous price (7680) (step 108) and the previous price>0 (step 116). Therefore we determine the transaction as an aggressive sale of 6 contracts to the passive buyer waiting at the bid price of 7675 (step 114). Upticks (7675)<Downticks (7675) (steps 138, 154, 156 and 158), so Downticks (7675)=Downticks (7675)−Upticks (7675) and we use as many O's as needed to represent the 6 contracts traded for the first time (step 160). We differentiate this attitude of lack of aggressiveness from part of the buyers and at the same time the anxious behavior of the sellers to hit the bid price.

Once again, the previous price is set to equal the current price (step 146). If the time period for the interval has expired (step 148) then the values are again initialized (step 102); otherwise, transaction information is again obtained from the exchange (step 106). Table 4 summarizes the values of each of the variables.

TABLE 4

| | Last | Current | | | | | |
|---|---|---|---|---|---|---|---|
| Trans | Price | Price | Size | Upticks(CP) | Downticks(CP) | Tendency | Display |
| 1 | 0 | 7675 | 3 | Upticks(7675) = 0 | Downticks(7675) = 0 | Null | I |
| 2 | 7675 | 7680 | 13 | Upticks(7680) = 13 | Downticks(7680) = 0 | UP | X's |
| 3 | 7680 | 7675 | 6 | Upticks(7675) = 0 | Downticks(7675) = 6 | Down | O's |
| 4 | 7675 | 7680 | 1 | | | | |

On this fourth transaction, the current price (7680) is above the previous price (7675) (step 108) and the previous price>0 (step 108). Therefore we determine the transaction as an aggressive purchase of 1 contract from a passive seller (steps 110, 112). Upticks (7680)>Downticks (7680) (steps 138, 140, 142 and 144). This fourth Transaction is assumed to be at the ask because it is greater than the Previous price and is accounted as one additional X on the price of 7680 since that price already had 13 making the total quantity transacted at that price as passive seller or aggressive buyers with 14.

According to a further aspect of the invention, a percentage of aggressive sales and aggressive purchases are calculated. More particularly, the percentage of aggressive sales is calculated by dividing the total number of aggressive sales for all prices at which goods were transacted during the period by the overall number of transactions during the period. Correspondingly, the percentage of aggressive purchases are calculated by dividing the total number of aggressive purchases for all prices at which goods were transacted during the period by the overall number of transactions during the period.

It should be appreciated that the overall number of transactions during the period is equal to the sum of the total number of aggressive sales for all prices at which goods were transacted during the period and the total number of aggressive purchases for all prices at which goods were transacted during the period.

It is important to distinguish between the adjusted total number of aggressive purchases (or sales) and the total number of aggressive purchases (or sales).

The adjusted total number of aggressive purchases is determined for a particular price, and entails reducing (offsetting) the number aggressive purchases Upticks (CP) by the number of aggressive sales Downticks (CP).

Correspondingly, the adjusted total number of aggressive sales is determined for a particular price, and entails reducing (offsetting) the number aggressive sales Downticks (CP) by the number of aggressive purchases Upticks (CP). The total number of aggressive purchases simply tracks the number of aggressive purchases during the time period without any offset for aggressive sales and irrespective of the transaction price. Likewise, the total number of aggressive sales simply tracks the number of aggressive sales during the time period without any offset for aggressive purchases and irrespective of the transaction price.

The total number of transactions is not equal to the sum of the adjusted total number of aggressive sales and the adjusted total number of aggressive purchases. Rather, the total number of transactions is equal to the sum of the total number of aggressive purchases and the total number of aggressive sales.

A percentage of aggressive sales may be calculated by dividing the total number of aggressive sales for the period by the total number of transactions.

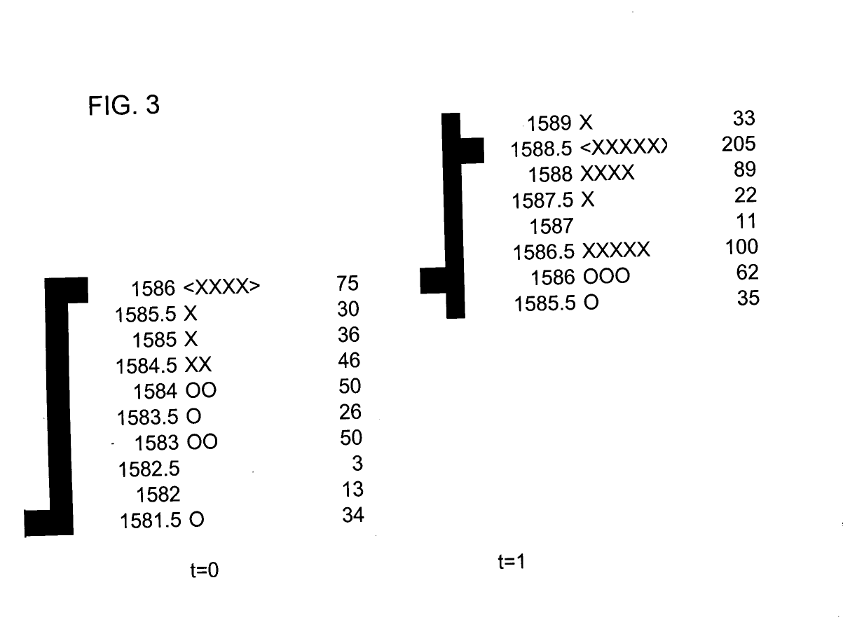

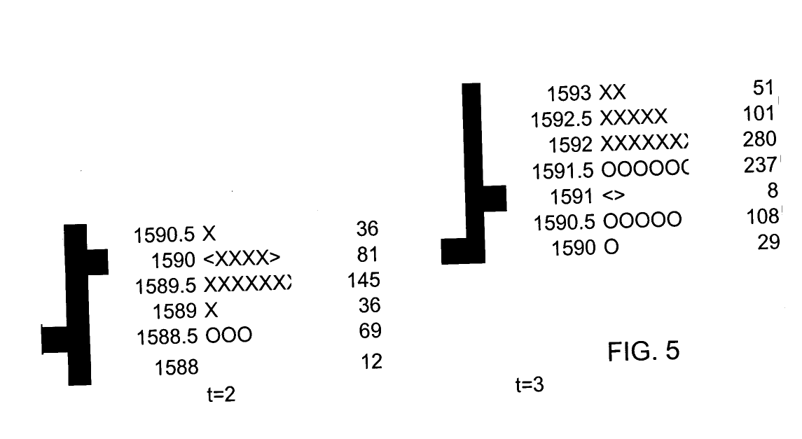

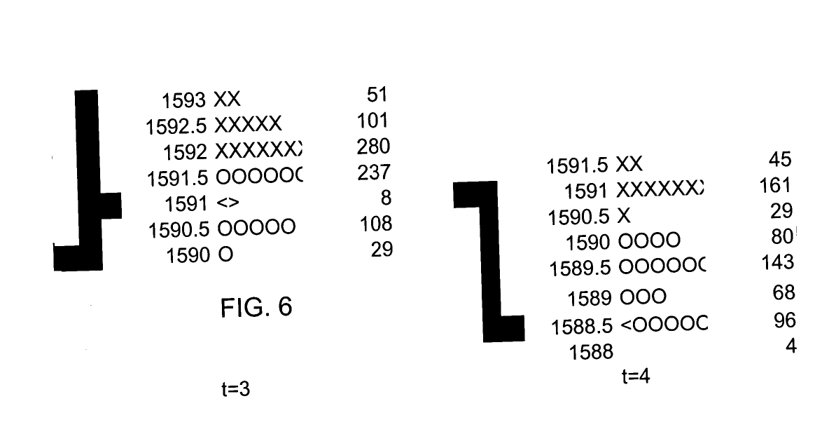

FIGS. 3-6 are diagrams created using the Market Activity Flow method of the present invention. It should be appreciated that the volume denotes the adjusted volume of aggressive buying/selling, and not the overall number of transactions at a give price. Notably, the number of aggressive purchases at a given price are reduced or offset by the number of aggressive sales at that price. Consequently, summing the volume at each of the prices will not yield the overall number of transactions within the time period. However, the overall number of aggressive purchases (U), overall number of aggressive sales (D), total overall number transaction (T=U+D), percentage of aggressive.

As seen in FIG. 3, at t=0 a significant amount of aggressive purchasing at $1610 (volume of 248) and an appreciable amount of aggressive selling occurred at $124 (volume of 124). The “volume” denotes the volume of aggressive buying/selling, and does not represent.

We can see the overwhelm buying against the 36% selling having this information will make us feel more comfortable buying in this period than if we only see a range of x amount of volume with no impact on every price.

At t=1 we see the same imbalance of buying versus selling that was present at t=0.

We see that 63% of the transactions were aggressive purchases, versus 37% aggressive sales on an overall volume of 835 transactions. It should be noted that this imbalance forced the price go higher from the previous time period.

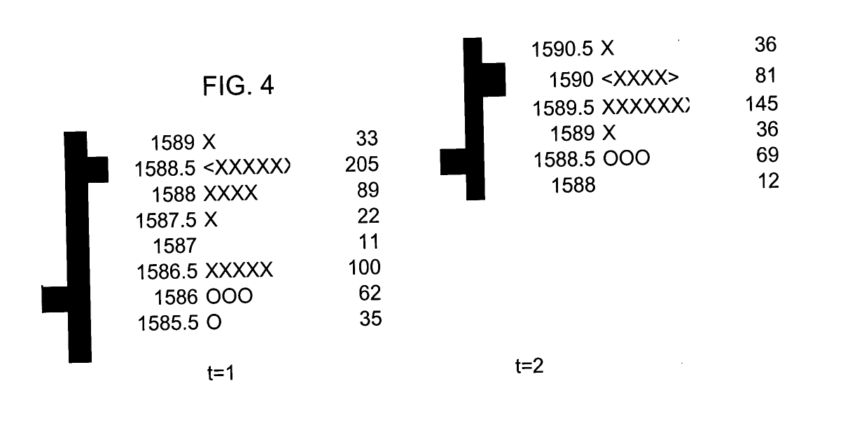

At t=2 (FIG. 4) we see that there was a significant amount of aggressive purchases at 1592 as well as a significant amount of aggressive selling at 1591.5, and the price at the end of the period denoted by < > is 1591. It should be appreciated that the present invention provides significantly more information than the conventional bar chart showing the range of prices during a period.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention.

1. A financial analysis system, comprising:
means for analyzing transaction information for a given item on a transaction by transaction basis to distinguish between aggressive buying and aggressive sales behavior at each price at which said item was transacted during a given time period; and
means for displaying the analyzed transaction information.

2. The financial analysis system of claim 1, wherein said transaction analysis means
calculates a running total of the number of aggressive buys occurring each said price during said time period,
calculates a running total of the number of aggressive sales occurring at each said price during said time period, and
calculates an aggregate total number of sales by subtracting the running total of the number of aggressive sales for a given price from the running total of the number of aggressive buys for said given price,
wherein if the aggregate total number is positive said display means displays the aggregate number as aggressive buys for the given price, and if the aggregate number is negative said display means displays the absolute value of the aggregate number as aggressive sales for the given price.

3. The financial analysis system of claim 1, wherein said transaction information includes a price and quantity of said given item involved in the transaction, and said transaction analysis means determines aggressive buying if the price of the current transaction is greater than the price of the previous transaction, and determines aggressive selling if the price of the current transaction is lesser than the price of the previous transaction.

4. The financial analysis system of claim 1, wherein said transaction analysis means:
calculates a running total of the number of aggressive purchases during said time period,
calculates a running total of the number of aggressive sales during said time period,
calculates a total number of transactions as the sum of the running total number of aggressive purchases and the total number of aggressive sales, and
calculates a percentage of aggressive purchases by dividing the total number of aggressive purchases by the total number of transactions.

5. The financial analysis system of claim 1, wherein said display means displays for each price at which said item was transacted during said time period at least one of (an adjusted number of aggressive purchases, an adjusted number of aggressive sales, and null in the case that the adjusted purchases equal the number of adjusted sales at a given price).
